(19) United States
(12) Patent Application Publication
(10) Pub. No.: US 2005/0173058 A1
(43) Pub. Date: Aug. 11, 2005

(54) Method for bonding flat glasses

(76) Inventors: Pie-Yau Chien, Taichung Hsien (TW); Jin-Teng Lin, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/774,514

(22) Filed: Feb. 10, 2004

(51) Int. Cl. B25B 1/20; C09J 1/00; B32B 31/00

(52) U.S. Cl. 156/281; 269/43

(57) ABSTRACT

A method for bonding flat glasses that adjusts proper conditions of bonding surfaces of the flat glasses and then compresses the flat glasses until two flat glasses bind by Ven Der Wall's interaction, an inherent interaction between molecules, to achieve a combined lens assembly. Moreover, heating may be used in the bonding method to decrease time for bonding the flat glasses and to enhance bonding strength. The combined lens assembly is simply bonded by molecular interaction without any adhesive or cohesive solution used in conventional bonding techniques.

### BACKGROUND OF THE INVENTION

1. Field of the Invention

The present invention relates to a method for bonding flat glasses, and more particularly to a bonding method that uses no adhesive or other cohesive substance and only a clamp to precisely and firmly laminate multiple flat glasses into a single optical lens assembly.

2. Description of Related Art

With regard to techniques of manufacturing high precision optical device such as high precision prisms and optical measuring instruments or techniques of copying optical characteristics from one device to another, a bonding method for flat glasses (optical contact) is an important factor in the success of producing such optical devices.

Two conventional methods for bonding flat glasses exist. One method uses an adhesive between two bonding surfaces to bond two flat glasses together. However, the adhesive easily deteriorates due to temperature variations, other environmental factors or process variations to reduce the bonding strength. Moreover, the adhesive has a different refractive index, forms a relatively thick interface that either distorts or reflects light passing through the optical device so that the optical device is not precise and not durable.

Another method uses a cohesive substance, such as water, in the process. In this method, pure water is applied between two curved bonding surfaces of two flat glasses both matching with each other. Then, the water is evaporated by heating, and the operational conditions during heating are: humidity: 50˜60% relative humidity and the degree of surface precision of the bonding surfaces: ¼λ (λ=632.8 nm). Ideally, the two bonding surfaces do not have any scratches or impurities, and the outlines of the two bonding surfaces have to precisely match each other when the bonding operation starts. When the water evaporates, the two bonding surfaces are bonded through hydroxide-catalyzed hydration and dehydration. However, in this method of bonding, tiny impurities are left between the two bonding surfaces to reduce the reliability of light transmission, and surface outline mismatches always exists with flat glasses having slightly concave bonding surfaces, which lowers the success rate in bonding.

To overcome the shortcomings, the present invention provides a method for bonding flat glasses to mitigate and obviate the aforementioned problems of conventional bonding methods.

### SUMMARY OF THE INVENTION

The main objective of the invention is to provide a method for bonding flat glasses, which increases the precision and light transmission efficiency of the lens assembly.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a method for bonding flat glasses in accordance with the present invention;

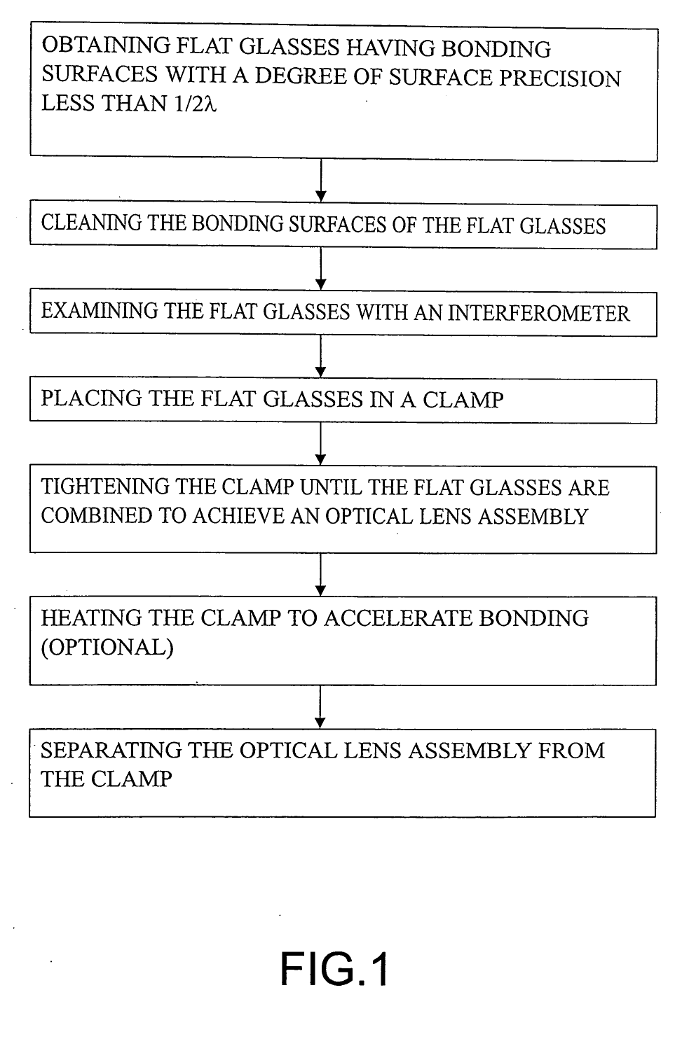

FIG. 2 is an operational perspective view of a clamping apparatus used in the bonding method in FIG. 1;

FIG. 3 is a detailed functional block diagram of a first embodiment of the bonding method in accordance with the present invention; and

FIG. 4 is a detailed functional block diagram of a second embodiment of the bonding method in accordance with the present invention.

### DETAILED DESCRIPTION OF PREFERRED EMBODIMENT

A method for bonding flat glasses in accordance with the present invention comprises the following acts:
obtaining flat glasses having bonding surfaces with a degree of surface precision less than ½λ;
cleaning the bonding surfaces of the flat glasses;
examining the flat glasses with an interferometer;
placing the flat glasses in a clamp;
optionally, heating the clamp;
compressing the flat glasses with the clamp until the flat glasses are combined with each other to achieve a lens assembly; and
removing the lens assembly from the clamp.

First, bonding surfaces of the flat glasses are polished with a polisher to make the degree of surface precision PV (peak to valley) about surface curvature of each bonding surface less than ½λ. Different kinds of flat glasses have different proper ranges of the degree of surface precision PV. With regard to a one-sided polished flat glass, the precision PV range of the bonding surface is preferred to be ¼˜⅓λ to achieve an excellent success rate of bonding. With regard to a double-sided polished flat glass, the degree of surface precision PV must be about ¼λ. Whereby, double-sided polished flat glasses are efficiently combined by compression with a clamp in a high temperature and low pressure environment even when the degree of surface precision PV is larger than ¼λ. With regard to a coated flat glass with bonding surfaces, the success rate of bonding is higher when the bonding surfaces of the coated glass is flatter.

Next, the bonding surfaces of the flat glasses are roughly cleaned in an ultrasonic solution of detergent and water. Then, the flat glasses are washed with pure water to remove impurities and washed again with highly volatile agents such as isopropanol. The volatile agent is water-soluble, dilutes and washes away water and dries the flat glasses without leaving a residue. If the flat glasses have to be coated, the flat glasses need to be degreased with sodium hydroxide and water before using the detergent.

After cleaning, the flat glasses are examined with brilliant light and a magnifier and checked with naked eyes based on a standard of International Organization for Standardization to define scratch levels. Flat glasses have a magnification power referred to as POWER, and most flat glasses have one or more astigmatisms. Consequently, the flat glasses are optionally examined with an interferometer to measure the POWER and Astigmatism Magnitude (ASTMAGE). When the POWER is positive, the curved surface is concave. When the POWER is negative, the curved surface is convex. The ASTMAGE is a measure of linear distortion in optics, which is defined by measuring whether two focal points located at an intersection of an optic axes of abscissa and ordinate are at the same point. When the two focal points are not located at the same position, the bonding surfaces of the flat glasses are mismatched or uneven.

To ensure that the bonding surfaces are clean, the flat glasses are washed again and placed sequentially inside the clamp. The flat glasses are examined by naked eyes under brilliant lighting to determine whether dust is on the bonding surfaces. If dust is on the bonding surfaces, an airbrush blows the dust away. Lastly, the clamp presses the cleaned flat glasses against each other. When the bonding surfaces of the flat glasses are fully in contact, Ven Der Waals interactions between the bonding surfaces inherently cause the flat glasses to firmly attach to each other.

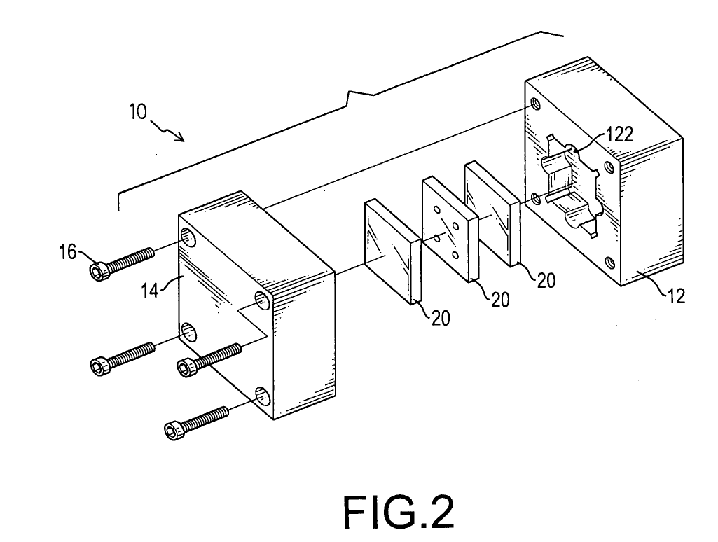

With reference to FIG. 2, the clamp (10) comprises a first pressure plate (12), a second pressure plate (14) and multiple bolts (16). The first pressure plate (12) has an abutting face (not numbered), a recess (122) defined in the abutting face and multiple threaded holes (not numbered). The second pressure plate (14) has multiple through holes (not numbered) corresponding respectively to the threaded holes in the first pressure plate (12). Three flat glasses (20) are axially placed sequentially between the first and the second pressure plates (12, 14) inside the recess (122). The bolts (16) pass respectively through the through holes in the second pressure plate (14) and screw tightly into threaded holes in the first pressure plate (12) to apply a force and squeeze the flat glasses together to combine them into a single lens assembly. A torque wrench (not shown) is used to measure the force applied by the bolts (16) to the flat glasses between the first and second pressure plates (12, 14). The force must be in a range of 1 kgf-cm to 5 kgf-cm. The preferred range of the force is 1.5 kgf-cm to 3 kgf-cm.

Then, the clamp may be heated to a temperature between 100° C. and 250° C. to decrease time for combining phenomenon of the flat glasses (20) and enhance the bonding strength thereof.

Additionally, bonding surfaces of coated flat glasses fabricated using the method described can be coated with a silica membrane and then are pressed together by the clamp. The flat glasses are heated to 250° C. with infrared to cause a molecular affinity between two bonding surfaces to join the coated flat glasses together in a single lens assembly.

The following examples demonstrate the efficiency of the bonding method in accordance with the present invention:

### EXAMPLE A

### Bonding of Two Non-Coated Flat Glasses

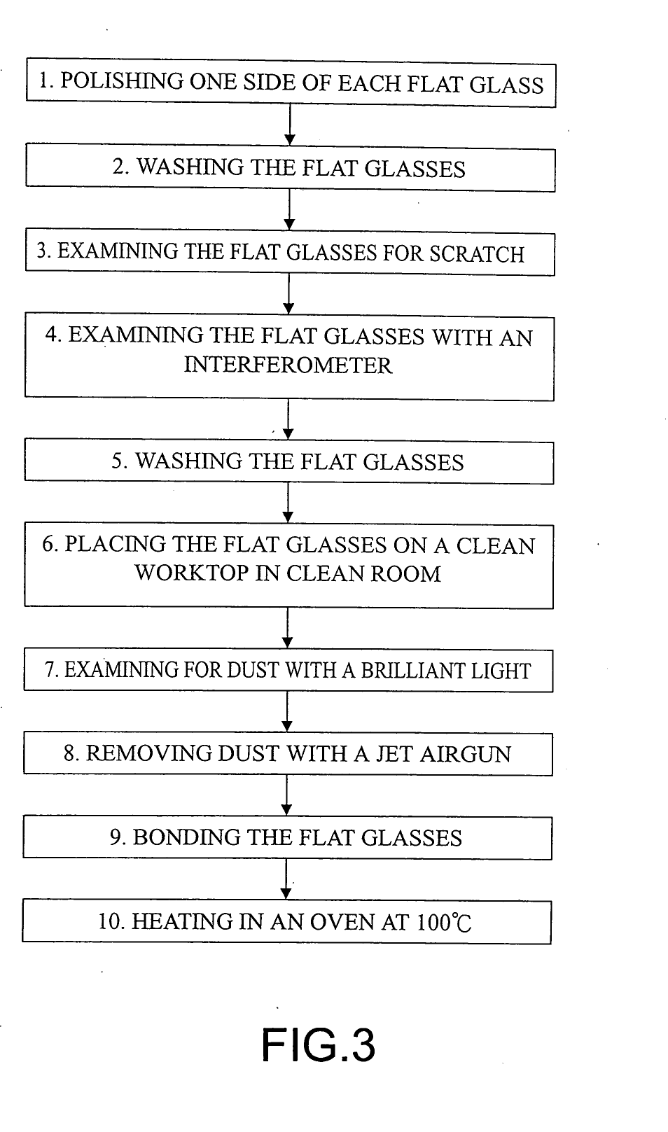

The steps of the procedure carried out in this example are shown in FIG. 3. The bonding surfaces of the flat glasses were polished to be slightly convex and then pressed together after cleaning to form the multilayered lens assembly.

Equipment:

DWDM four-axis polisher; rotational speed: 20 revolutions per minute; time: dependent factor; polishing head pressure: 0.75 kg/cm²; polishing dish: #1650 polishing paper; polishing agent: ferric oxide; lab: clean room; degree of cleanliness: class 10,000; number of flat glasses: 22 pieces (11 sets); material: schott-B270; size: 20×20×3 mm; hardness: HK100:542; the flat glasses are divided into two types, one type is flat glasses having four holes of diameter φ 2.5 mm (indicated by W in the serial number) and the other type is flat glasses having no holes (indicated by S in the serial number).
   A1. Bonding of Two One-Piece Non-Coated Flat Glasses Having Four Holes of Diameter φ 2.5 mm

22 non-coated flat glasses having holes have W in the serial number, and two non-coated flat glasses were bonded together to form combined lens assemblies. Each flat glass of combined the lens assemblies was examined to measure the degree of surface precision (PV), POWER and ASTMAG, and listed in Table A1.

TABLE A1
Polishing time: 60 sec

| | | Average value for | Average value for |
|---|---|---|---|
| Serial numbers | Measurement | first flat glass | second flat glass |
| W-0101 | PV (μm) | 0.185 | 0.536 |
| W-0201 | POWER (nm) | −139.06 | −419.905 |
| Set 1 | ASTMAG (fr) | 0.148 | 0.219 |
| W-0301 | PV (μm) | 0.164 | 0.259 |
| W-0401 | POWER (nm) | −92.498 | −186.631 |
| Set 2 | ASTMAG (fr) | 0.226 | 0.133 |
| W-0501 | PV (μm) | 0.272 | 0.319 |
| W-0601 | POWER (nm) | −139.994 | −227.002 |
| Set 3 | ASTMAG (fr) | 0.119 | 0.123 |
| W-0701 | PV (μm) | 0.3 | 0.293 |
| W-0801 | POWER (nm) | −174.305 | −186.117 |
| Set 4 | ASTMAG (fr) | 0.274 | 0.21 |
| W-0901 | PV (μm) | 0.273 | 0.232 |
| W-1001 | POWER (nm) | −138.72 | −102.648 |
| Set 5 | ASTMAG (fr) | 0.303 | 0.007 |
| W-1101 | PV (μm) | 0.216 | 0.244 |
| W-1201 | POWER (nm) | −145.897 | −182.618 |
| Set 6 | ASTMAG (fr) | 0.271 | 0.115 |
| W-1301 | PV (μm) | 0.334 | 0.277 |
| W-1401 | POWER (nm) | −136.149 | −165.03 |
| Set 7 | ASTMAG (fr) | 0.523 | 0.164 |
| W-1501 | PV (μm) | 0.76 | 0.317 |
| W-1601 | POWER (nm) | −733.908 | −201.97 |
| Set 8 | ASTMAG (fr) | 0.506 | 0.282 |
| W-1701 | PV (μm) | 0.233 | 0.259 |
| W-1801 | POWER (nm) | −196.746 | −194.369 |
| Set 9 | ASTMAG (fr) | 0.162 | 0.145 |
| W-1901 | PV (μm) | 0.25 | 0.128 |
| W-2001 | POWER (nm) | −138.35 | 46.831 |
| Set 10 | ASTMAG (fr) | 0.246 | 0.107 |
| W-2101 | PV (μm) | 0.268 | 0.087 |
| W-2201 | POWER (nm) | −138.452 | 16.466 |
| Set 11 | ASTMAG (fr) | 0.234 | 0.046 |

All sets of the two-piece lens assemblies in Table A1 were eventually combined. That slightly convex bonding surfaces had an excellent success rate of bonding and not only bonding surfaces having a degree of surface precision PV of ¼λ (0.1582 nm) can achieve the combination was remarkable. This example illustrates that even when the bonding surfaces of the flat glasses are scraggy, the bonding operation can be optionally performed at room temperature without heating.

A.2. Bonding of Two Non-Coated Flat Glasses without Holes

16 non-coated flat glasses without holes have S in the serial number, and two non-coated flat glasses were bonded together to form combined optical devices (8 sets). Each flat glass of the combined optical devices was examined to measure the degree of surface precision degree (PV), POWER and ASTMAG, and listed in Table A2.

TABLE A2
Polishing time: 40 sec

| | | Average value for | Average value for |
|---|---|---|---|
| Serial numbers | Measurement | first flat glass | second flat glass |
| S-0501 | PV (μm) | 0.192 | 0.147 |
| S-0602 | POWER (nm) | −136.632 | −103.352 |
| Set 1 | ASTMAG (fr) | 0.09 | 0.21 |
| S-0601 | PV (μm) | 0.157 | 0.149 |
| S-1201 | POWER (nm) | −89.161 | 31.291 |
| Set 2 | ASTMAG (fr) | 0.59 | 0.2 |
| S-1002 | PV (μm) | 0.135 | 0.208 |
| S-0902 | POWER (nm) | −67.441 | −8.77 |
| Set 3 | ASTMAG (fr) | 0.25 | 0.24 |
| S-1102 | PV (μm) | 0.162 | 0.205 |
| S-1302 | POWER (nm) | −76.832 | −62.591 |
| Set 4 | ASTMAG (fr) | 0.41 | 0.5 |
| S-0801 | PV (μm) | 0.166 | 0.142 |
| S-0701 | POWER (nm) | −27.099 | −11.997 |
| Set 5 | ASTMAG (fr) | 0.25 | 0.21 |
| S-2402 | PV (μm) | 0.243 | 0.191 |
| S-2103 | POWER (nm) | −132.249 | 0.135 |
| Set 6 | ASTMAG (fr) | 0.3 | 0.168 |
| S-2401 | PV (μm) | 0.21 | 0.126 |
| S-2003 | POWER (nm) | −105.545 | 17.204 |
| Set 7 | ASTMAG (fr) | 0.33 | 0.225 |
| S-1901 | PV (μm) | 0.457 | 0.457 |
| S-2001 | POWER (nm) | −337.957 | −418.850 |
| Set 8 | ASTMAG (fr) | 0.141 | 0.58 |

All sets of the two-piece optical devices in Table A2 were eventually combined. That slightly scraggy bonding surfaces with a degree of surface precision (PV) of ¼˜⅓λ, POWER of −400˜−10 nm and ASTMAG of 0.2˜0.45 f.r. have such an excellent success rate of bonding is remarkable.

According to the results of A1 and A2, one feature of the present invention is noticed that when the POWER value of the combined flat glass assembly is negative, success rate of binding is high. The other feature is that not only binding surfaces having precision degree PV less than ¼ λ can achieve the combination.

### Example B

### Three-Piece Bonding of Non-Coated Flat Glasses

The flat glasses are polished and placed into the clamp to bond three flat glasses into a single combined lens assembly.
Equipment: vacuum heating chamber; temperature: 200° C.; pressure 10⁻⁴ Pascal; Numbers of flat glass: 21 pieces (7 sets); material: schott-B270; size: 20×20×3 mm; hardness: HK₁₀₀:542; Lab: clean room; clean degree: class 10,000.

The flat glasses are divided into two types, one type is flat glasses having four holes of diameter φ 2.5 mm (indicated with a t or n in the serial number) and the other type is flat glasses having no hole (indicated with an s or k in the serial number).

B1 Three-Piece Bonding of Non-Coated Flat Glasses

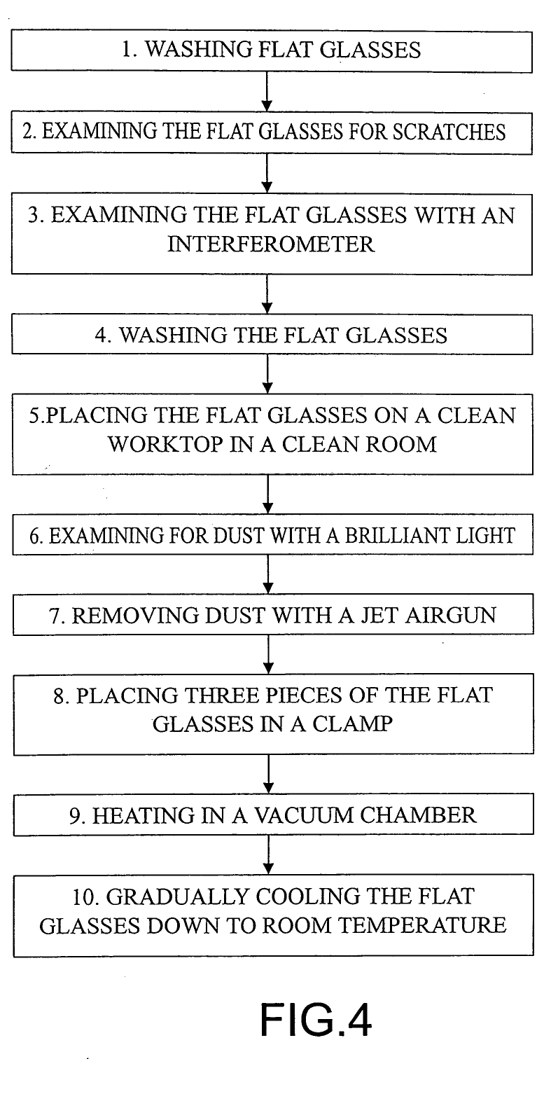

The specific steps performed in example B1 are shown in FIG. 4, and three non-coated flat glasses were placed and stressed in the clamp and heated in a vacuum heat chamber for 6 hours at 200° C. to form a combined lens assembly (7 sets in total). The combined lens assemblies were cooled from 200° C. to room temperature in 2 hours.

Each flat glass of the combined flat glasses assemblies was examined to measure the degree of surface precision (PV), POWER and ASTMAG, and listed in Table B1, wherein s and k in the serial number indicate non-coated flat glasses without holes; and t and n in the serial number indicate non-coated flat glasses having four holes of diameter φ 2.5 mm.

TABLE B1

| | | First | Second | Third | Fourth | |
|---|---|---|---|---|---|---|
| Serial | | Bonding | bonding | bonding | bonding | |
| Numbers | Measurement | surface | surface | surface | surface | Notation |
| s-02 | PV (μm) | 4.878 | 0.104 | 0.74 | 0.199 | Incomplete |
| s-01 | POWER(nm) | −4307.169 | −18.388 | −637.652 | −63.098 | Set 1 |
| t-03 | ASTMAG(fr) | 6.28 | 0.11 | 0.67 | 0.43 | |
| s-17 | PV(μm) | 0.083 | 0.233 | 0.212 | 0.113 | Incomplete |
| t-17 | POWER(nm) | −45.647 | −196.782 | −54.646 | −48.531 | Set 2 |
| s-18 | ASTMAG(fr) | 0.013 | 0.162 | 0.101 | 0.354 | |
| s-13 | PV(μm) | 0.205 | 0.159 | 0.253 | 0.133 | Success |
| t-15 | POWER(nm) | −62.591 | −114.44 | −138.428 | −114.127 | Set 3 |
| s-16 | ASTMAG(fr) | 0.5 | 0.021 | 0.344 | 0.221 | |
| k-1 | PV(μm) | 0.231 | 0.156 | 0.165 | 0.123 | Success |
| n-1 | POWER(nm) | 34.79667 | 27.837 | 49.46 | −43.0473 | Set 4 |
| k-2 | ASTMAG(fr) | 0.093 | 0.09 | 0.1 | 0.273 | |
| k-3 | PV(μm) | 0.105 | 0.318 | 0.151 | 0.073 | Success |
| n-2 | POWER(nm) | 14.13467 | 68.718 | 68.684 | 31.523 | Set 5 |
| k-4 | ASTMAG(fr) | 0.22 | 0.18 | 0.03 | 0.167 | |
| k-5 | PV(μm) | 0.104 | 0.173 | 0.2 | 0.11 | Success |
| n-3 | POWER(nm) | 1.518 | 64.01 | 29.135 | 12.586 | Set 6 |
| k-6 | ASTMAG(fr) | 0.2 | 0.12 | 0.08 | 0.236 | |
| k-7 | PV(μm) | 0.113 | 0.159 | 0.11 | 0.079 | Incomplete |
| n-4 | POWER(nm) | 62.173 | 59.13 | 23.498 | 0.709 | Set 7 |
| k-8 | ASTMAG(fr) | 0.27 | 0.42 | 0.18 | 0.07 | |

Although all sets of three-piece combined lens assemblies were eventually combined, the resultant assemblies still had some defects. For example, multiple stripes appeared at the interface between a first bonding surface and a second bonding surface in set 1. The strips were caused by mismatches in the outline of the first and second bonding surfaces. Set 2 has color and white reflection areas that were caused from a mismatch in the bonding surfaces. Reflection areas appeared in set 7 after two days. Other flat glass assemblies have tiny particles between flat glasses near the edges, and the cleanliness of the flat glasses before assembly needs to be improved.

Example B1 demonstrated that double-sided polished flat glasses with a surface precision PV of ¼λ can be well bonded in a high temperature and low pressure environment by compression without having slightly convex bonding surfaces.

B2. Three-Piece Bonding of Coated Flat Glasses

Three coated flat glasses are placed and compressed in a clamp and heated in a vacuum heat chamber for 6 hours from room temperature to 200° C. to form a combined lens assembly (7 sets in total). The combined lens assemblies were cooled from 200° C. to room temperature in 2 hours.

Each flat glass of the combined flat glass assemblies was examined to measure the degree of surface precision (PV), POWER and ASTMAG, and listed in Table B2.

TABLE B2

| | | First | Second | Third | Fourth | |
|---|---|---|---|---|---|---|
| serial | | bonding | bonding | bonding | bonding | |
| number | measurement | surface | surface | surface | surface | Stripes |
| L-02 | PV(um) | 0.214 | 0.124 | 0.113 | 1.414 | Set 1 |
| N-01 | POWER(nm) | −98.88 | −29.379 | −3.079 | −1385.51 | |
| M-05 | ASTMAG(fr) | 0.4 | 0.19 | 0.19 | 0.13 | |
| L-03 | PV(um) | 0.163 | 0.151 | 0.2 | 1.431 | Set 2 |
| N-10 | POWER(nm) | −144.876 | 68.684 | 29.135 | −1425.82 | |
| M-11 | ASTMAG(fr) | 0.48 | 0.03 | 0.08 | 0.26 | |
| L-05 | PV(um) | 0.194 | 0.11 | 0.165 | 1.344 | Set 3 |
| N-14 | POWER(nm) | −164.6 | 23.498 | −5.05 | −1369.79 | |
| M-14 | ASTMAG(fr) | 0.41 | 0.18 | 0.14 | 0.52 | |
| L-08 | PV(um) | 0.089 | 0.156 | 0.115 | 1.392 | Set 4 |
| N-16 | POWER(nm) | −71.815 | 27.837 | 1.399 | −1380.79 | |
| M-15 | ASTMAG(fr) | 0.27 | 0.09 | 0.09 | 0.24 | |
| L-09 | PV(um) | 0.154 | 0.112 | 0.165 | 1.343 | Set 5 |
| N-18 | POWER(nm) | −106.647 | 27.794 | 49.46 | −1342.73 | |
| M-17 | ASTMAG(fr) | 0.18 | 0.03 | 0.1 | 0.08 | |
| L-10 | PV(um) | 0.177 | 0.146 | 0.127 | 1.38 | Set 6 |
| N-19 | POWER(nm) | −75.586 | 56.109 | 21.657 | −1393.52 | |
| M-18 | ASTMAG(fr) | 0.43 | 0.1 | 0.16 | 0.2 | |
| L-11 | PV(um) | 0.187 | 0.173 | 0.159 | 1.331 | Set 7 |
| N-20 | POWER(nm) | −110.339 | 64.01 | 59.13 | −1401.49 | |
| M-19 | ASTMAG(fr) | 0.41 | 0.12 | 0.42 | 0.33 | |

Although all sets of combined lens assemblies are hard to separate with hands, the combined lens assemblies have stripes exited in each set. Set 3 and set 5 have bonding area more than 80% but also has stripes supposed to be caused from overly coating membrane. However, the flat glasses with POWER value of −1000˜−50 nm and ASTMAG value of 0.2˜0.45 f.r. have excellent success rate of bonding.

According to the results of the experiments in examples A1, and A2, non-clad flat glasses with slightly scraggy bonding surfaces are successfully bonded when surface precision PV is ¼˜⅓λ, POWER is −250˜−75 nm and ASTMAG is 0.2˜0.45 f.r. According to examples B1 and B2, double-sided polishing flat glasses with ¼λ PV bonding surfaces can be well bonded under high temperature and low pressure conditions by compression without slightly scraggy bonding surfaces. With regard to coated flat glasses, if the coating membrane on the bonding surface is flatter, the success rate of bonding is better.

In the method for bonding flat glass, the flat glasses can be firmly bonded without any adhesive or cohesive substance, which reduces production cost. Furthermore, since no adhesive is used between the bonding surfaces, no thick interface is generated to block the light transmission or cause degeneration problem so that the lens assembly is precise and durable and has high light transmissibility. Therefore, the lens assemblies made with the bonding method are especially suitable for inner components of light communicating devices, laser guns or other thermal-sensitive optical products.

Even though numerous advantages of the present invention have been set forth in the foregoing description, the disclosure is illustrative only. Changes may be made in detail within the principles of the invention to the full extent indicated by the broad general meaning of the terms in which the appended claims are expressed.

1. A method for bonding flat glasses comprising the steps of:
obtaining flat glasses having bonding surfaces with a surface precision degree less than ½λ (λ=632.8 nm.);
cleaning the bonding surfaces of the flat glasses;
placing the flat glasses in a clamp;
tightening the clamp until the flat glasses are combined with each other to achieve an optical lens assembly; and
separating the optical lens assembly from the clamp.

2. The method for bonding flat glasses as claimed in claim 1, wherein the cleaning step uses an ultrasonic solution to clean the flat glasses, and then uses a volatile solvent to clean and dry the flat glasses.

3. The method for bonding flat glasses as claimed in claim 1 further comprising a step of examining the flat glasses with an interferometer to check whether contaminants left on the bonding surfaces after the cleaning step.

4. The method for bonding flat glasses as claimed in claim 1 further comprising a step of heating the clamp to decrease time for combining the flat glasses when the clamp is tightened.

5. The method for bonding flat glasses as claimed in claim 3 further comprising a step of blowing dust off the bonding surfaces with an airbrush after the step of examining the flat glasses.

6. the method for bonding flat glasses as claimed in claim 4, wherein the clamp is preferably heated to a temperature between 100° C. and 250° C.

7. A method for bonding flat glasses comprising the steps of:
obtaining flat glasses having bonding surfaces with surface precision degree less than ½λ (λ=632.8 nm);
cleaning the bonding surfaces of the flat glasses in an ultrasonic solution and a volatile solvent;
examining the flat glasses with an interferometer to check surface precision of the flat glasses and to ensure that no contaminant is on the bonding surfaces;
placing the flat glasses in a clamp;
tightening the clamp until the flat glasses are combined with each other to achieve an optical lens assembly; and
separating the optical lens assembly from the clamp.

8. The method for bonding flat glasses as claimed in claim 7 further comprising a step of heating the clamp to accelerate combination of the flat glasses after the act of tightening the clamp.

9. The method for bonding flat glasses as claimed in claim 7 further comprising a step of removing dust from the bonding surfaces with an airbrush after the act of examining the flat glasses.

10. The method for bonding flat glasses as claimed in claim 8, wherein the clamp is preferably heated to a temperature between 100° C. and 250° C.

11. A method for bonding flat glasses comprising the steps of:
obtaining flat glasses having bonding surfaces with surface precision degree less than ½λ;
cleaning the bonding surfaces of the flat glasses in an ultrasonic solution and a volatile solvent;
examining the flat glasses with an interferometer to check surface precision of the flat glasses and ensure no contaminant is on the bonding surfaces;
placing the flat glasses in a clamp;
tightening the clamp until the flat glasses are combined with each other to achieve an optical lens assembly;
heating the clamp to a temperature between 100° C. and 250° C. to decrease time for combining the flat glasses; and
separating the optical lens assembly from the clamping apparatus.

12. The method for bonding flat glasses as claimed in claim 11 further comprising a step of removing dust from the bonding surfaces with an airbrush after the step of examining the flat glasses.

13. (canceled)
